(19) United States
(12) Patent Application Publication
(10) Pub. No.: US 2007/0072769 A1
(43) Pub. Date: Mar. 29, 2007

(54) CARBON DIOXIDE ABSORBENT AND CARBON DIOXIDE SEPARATION APPARATUS

(76) Inventors: Toshihiro Imada, Yokohama-shi (JP); Masahiro Kato, Naka-gun (JP); Kenji Essaki, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/535,303

(22) Filed: Sep. 26, 2006

(30) Foreign Application Priority Data
Sep. 28, 2005 (JP) 2005-281653

(51) Int. Cl. B01J 20/10; B01J 8/02; B01D 53/00

(52) U.S. Cl. 502/411; 422/178; 422/177; 422/173; 96/108; 96/146

(57) ABSTRACT

A carbon dioxide absorbent of the invention comprises (a) a lithium silicate and (b) an absorption promoter containing potassium carbonate and sodium carbonate at a mole ratio of (sodium carbonate)/(potassium carbonate) in a range from 0.125 to 0.4, and the absorption promoter (b) is contained in an amount from 0.5 to 4.9% by mole based on the total amount of the lithium silicate (a) and the absorption promoter (b).

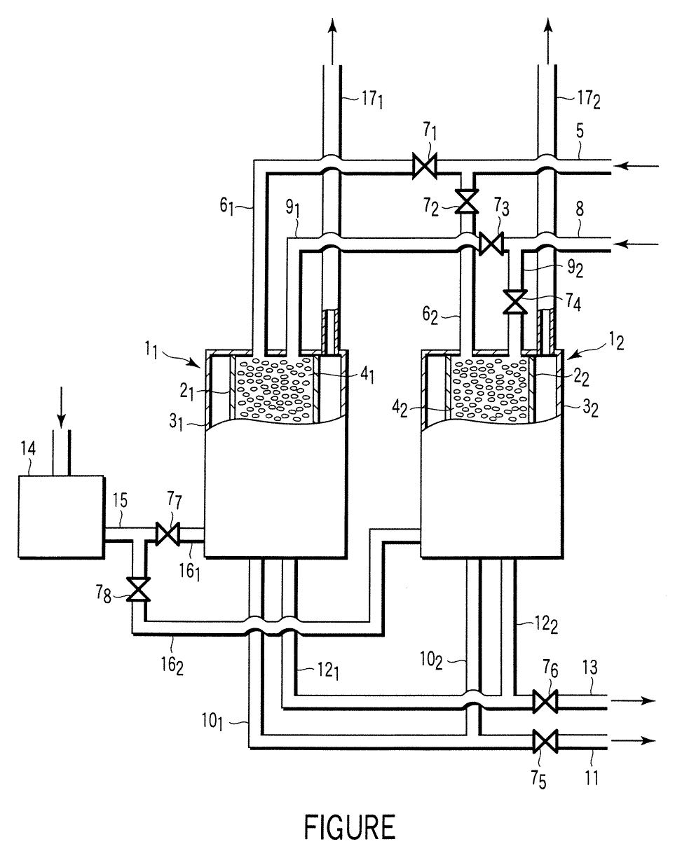

### CROSS-REFERENCE TO RELATED APPLICATIONS

This application is based upon and claims the benefit of priority from prior Japanese Patent Application No. 2005-281653, filed Sep. 28, 2005, the entire contents of which are incorporated herein by reference.

### BACKGROUND OF THE INVENTION

1. Field of the Invention

The invention relates to a carbon dioxide absorbent and a carbon dioxide separation apparatus, and particularly, to a carbon dioxide absorbent capable of absorbing high temperature carbon dioxide emitted by a combustion apparatus or the like and desorbing carbon dioxide, and a carbon dioxide separation apparatus having the carbon dioxide absorbent.

2. Description of the Related Art

With respect to a combustion apparatus for burning a fuel consisting mainly of a hydrocarbon, such as an engine, the temperature of a carbon dioxide recovery point where a combustion gas is emitted is often as high as 300° C. or higher. As a method of separating carbon dioxide, chemical absorption methods, e.g. a method of using cellulose acetate and a method of using an alkanol amine type solvent have conventionally been known. However, in the case of these separation methods, the temperature of the gas to be introduced has to be 200° C. or lower. Accordingly, in order to separate carbon dioxide from a combustion gas required for recycling at a high temperature, it is required to cool the combustion gas once to 200° C. or lower by means of a heat exchanger or the like. As a result, there occurs a problem that the energy consumption for carbon dioxide separation is increased.

Jpn. Pat. Appln. KOKAI Publication Nos. 9-99214 and 2000-262890 disclose methods of separating carbon dioxide from high temperature carbon dioxide-containing gases in a temperature range exceeding 500° C. using lithium composite oxides reactive on carbon dioxide without a cooling step. These lithium composite oxides absorb carbon dioxide by reaction with carbon dioxide and decomposition into oxides and lithium carbonate. Further, reverse reaction of the oxides and lithium carbonate produced by the reaction of these lithium composite oxides and carbon dioxide is often caused at a higher temperature. Therefore, the lithium composite oxides are made repeatedly usable. Jpn. Pat. Appln. KOKAI Publication No. 2000-262890 also describes use of lithium silicate that is easy to synthesize and having high absorption speed as a carbon dioxide absorbent. Further, it is described that addition of carbonates to the lithium silicate improves the carbon dioxide absorption properties and heightens the efficiency of absorption of carbon dioxide in a low concentration at a low temperature.

However, if the absorption and desorption reactions of carbon dioxide are repeated many times by using carbon dioxide absorbents containing lithium silicate, the carbon dioxide absorption capability gradually deteriorates. For this reason, it has been difficult to maintain high carbon dioxide absorption capability for a long duration.

### BRIEF SUMMARY OF THE INVENTION

According to a first aspect of the present invention, there is provided a carbon dioxide absorbent comprising:

(a) lithium silicate; and

(b) an absorption promoter containing potassium carbonate and sodium carbonate at a mole ratio of (sodium carbonate)/(potassium carbonate) in a range from 0.125 to 0.4,

Wherein the absorption promoter (b) is contained in an amount of 0.5 to 4.9% by mole based on the total amount of the lithium silicate (a) and the absorption promoter (b).

According to a second aspect of the present invention, there is provided a carbon dioxide separation apparatus comprising:

a reaction container having an inlet port which introduces carbon dioxide and an exhaust port which discharges a produced gas;

a carbon dioxide absorbent housed in the reaction container and comprising: (a) lithium silicate; and (b) an absorption promoter containing potassium carbonate and sodium carbonate at a mole ratio of (sodium carbonate)/(potassium carbonate) in a range from 0.125 to 0.4, the absorption promoter being contained in an amount of 0.5 to 4.9% by mole based on the total amount of the lithium silicate (a) and the absorption promoter (b); and

heating means installed in the outer circumference of the reaction container, for supplying heat to the reaction container.

### BRIEF DESCRIPTION OF THE SEVERAL VIEWS OF THE DRAWING

The single FIGURE is a schematic cross-sectional view showing a carbon dioxide separation apparatus according to an embodiment of the present invention.

### DETAILED DESCRIPTION OF THE INVENTION

Hereinafter, a carbon dioxide absorbent and a carbon dioxide separation apparatus according to an embodiment of the present invention will be described in detail.

A carbon dioxide absorbent according to the embodiment comprises (a) a lithium silicate and (b) an absorption promoter containing potassium carbonate and sodium carbonate at a mole ratio of (sodium carbonate)/(potassium carbonate) in a range from 0.125 to 0.4. The absorption promoter (b) is contained in an amount of 0.5 to 4.9% by mole based on the total amount of the lithium silicate (a) and the absorption promoter (b).

The lithium silicate to be used may include those defined by the formula LiₓSi_{y}O_{z} (wherein x+4y−2z=0). Examples usable as the lithium silicate defined by the above-mentioned formula include lithium orthosilicate (Li₄SiO₄), lithium metasilicate (Li₂SiO₃), Li₆Si₂O₇, and Li₈SiO₆. Particularly, lithium orthosilicate is preferable because it has a high absorption and desorption temperature and is capable of separating carbon dioxide gas at a high temperature. These lithium silicates may actually have compositions more or less different from the stoichiometric ratios shown in the chemical formulas. The carbon dioxide absorption reaction and regeneration reaction of lithium orthosilicate are defined as the following reaction formulas (1) and (2), respectively.
Absorption: Li₄SiO₄+CO₂→Li₂SiO₃+Li₂CO₃ (1)
Desorption: Li₂SiO₃+Li₂CO₃→Li₄SiO₄+CO₂ (2)

The lithium orthosilicate absorbs carbon dioxide with the reaction defined by the above reaction formula (1) by being heated at a temperature in an absorption temperature range (first temperature) from a room temperature to about 700° C. to produce lithium metasilicate (Li₂SiO₃) and lithium carbonate (Li₂CO₃). In the case where the carbon dioxide absorbent having absorbed carbon dioxide is heated to a temperature (second temperature) exceeding the above-mentioned absorption temperature range, the absorbent desorbs carbon dioxide with the reaction defined by the reaction formula (2) to regenerate lithium orthosilicate as before. The carbon dioxide absorption in the carbon dioxide absorbent and regeneration of the carbon dioxide absorbent as described above can be repeated. The absorption temperature range of carbon dioxide changes depending on the carbon dioxide concentration in the reaction atmosphere, and as the carbon dioxide concentration becomes higher, the upper limit temperature of the absorption temperature range becomes higher.

The above-mentioned absorption promoter having the mole ratio of (sodium carbonate)/(potassium carbonate) in a range from 0.125 to 0.4 improves the carbon dioxide-absorbing property of the lithium orthosilicate and the repeating property of absorbing and desorbing carbon dioxide. Further, the promoter makes the lithium orthosilicate to efficiently absorb carbon dioxide in a low concentration. The mole ratio of (sodium carbonate)/(potassium carbonate) in the lithium orthosilicate is more preferably in a range from 0.15 to 0.3, most preferably in a range from 0.2 to 0.25.

The absorption promoter is contained in an amount of 0.5 to 4.9% by mole based on the total amount of lithium silicate and the absorption promoter, and efficiently promotes the carbon dioxide-absorbing capability. If the amount of the absorption promoter is lower than 0.5% by mole, it becomes difficult to sufficiently exhibit the effect of the absorption promoter to increase the carbon dioxide-absorbing property. On the other hand, if the amount of the absorption promoter exceeds 4.9% by mole, not only the effect of the absorption promoter to improve the carbon dioxide-absorbing property is saturated, but also the ratio of the lithium silicate in the carbon dioxide absorbent is decreased to possibly result in decrease of the carbon dioxide absorption amount and absorption speed. The amount of the absorption promoter is more preferably in a range from 2 to 4% by mole based on the total amount of lithium silicate and the absorption promoter.

The carbon dioxide absorbent according to the embodiment is allowed to further contain, for example, a granular or fibrous titanium-containing oxide. Examples of the titanium-containing oxide may include potassium titanate, titanium oxide, and lithium titanate. These titanium-containing oxides have an effect to prevent the lithium silicate particles of the carbon dioxide absorbent from becoming coarse. An amount of the titanium-containing oxide is preferably 40% by weight or lower based on the total amount of the above-mentioned components (a) and (b) and the titanium-containing oxide. If the amount of the titanium-containing oxide exceeds 40% by weight, the ratio of the carbon dioxide absorbent component is decreased, and it may possibly become difficult to sufficiently absorb carbon dioxide.

The carbon dioxide absorbent according to the embodiment has, for example, a granular, column-like, disk-like, or spherical shape. The carbon dioxide absorbent is preferable to have an average diameter of 50 μm or larger. If the average diameter is smaller than 50 μm, a pressure loss of a gas may become high in the case where the carbon dioxide absorbent is filled in a desired container and a carbon dioxide-containing gas is introduced into the container. The average diameter of the carbon dioxide absorbent is preferably to be limited to be 30 mm in the upper limit.

In the case where the size of the carbon dioxide absorbent is made, for example, not smaller than 5 mm, it is preferable to make the carbon dioxide absorbent be a porous material or have a honeycomb structure so as to increase the contact surface area with the carbon dioxide-containing gas. The porous material preferably has a porosity in a range from 30 to 70%. Such a porous material or honeycomb structure can be formed by granulation or extrusion molding. In the case of molding, a binder material for binding the granules of lithium silicate or the like may be used. The binder material to be used include both of inorganic materials and organic materials. Practical examples of the inorganic materials include clay, minerals, and milk of lime. Practical examples of the organic materials include starch powder, methyl cellulose, polyvinyl alcohol, and paraffin. The binder material may be added in form of a solution while being dissolved in a proper solvent. Water or an organic solvent may be used as the solvent. The addition amount of the binder material is desired to be in a range from 0.1 to 20% by weight to the lithium silicate. If the addition amount of the binder material is lower than 0.1% by weight, it becomes difficult to sufficiently bind the granules. If the addition amount of the binder material exceeds 20% by weight, on the other hand, the ratio of the lithium silicate in the carbon dioxide absorbent is lowered to possibly decrease the carbon dioxide absorption amount.

The carbon dioxide absorbent according to the embodiment described above comprises (a) a lithium silicate and (b) an absorption promoter containing potassium carbonate and sodium carbonate at a mole ratio of (sodium carbonate)/(potassium carbonate) in a range from 0.125 to 0.4, and the absorption promoter is contained in an amount of 0.5 to 4.9% by mole based on the total amount of the lithium silicate (a) and the absorption promoter (b). As a consequence, the carbon dioxide-absorbing property can be improved, and carbon dioxide in a low concentration can be absorbed efficiently. Further, the carbon dioxide-absorbing capability is kept high even if absorption and desorption of carbon dioxide is repeated.

That is, alkaline carbonates such as potassium carbonate and sodium carbonate are effective to liquefy solid state lithium carbonate formed in the surface at the time of absorbing carbon dioxide by the lithium silicate, increase the diffusion speed of carbon dioxide, and thus accelerate the carbon dioxide absorption speed. However, if the carbon dioxide adsorption reaction and desorption reaction are repeated many times by the carbon dioxide absorbent containing the alkaline carbonates, the carbon dioxide absorption capability is gradually decreased and degraded.

The inventors have made various investigations on decrease of the carbon dioxide absorption capability of the carbon dioxide absorbent containing a lithium silicate (e.g., lithium orthosilicate) and alkaline carbonates. As a result, the inventors have found that the lithium carbonate turned to be in a liquid phase by the function of the alkaline carbonates at the time of absorption and desorption of carbon dioxide at a high temperature wets the surface of lithium metasilicate in the vicinity to lower the surface energy and leads to growth of the lithium silicate granules, and that owing to the grain growth, the porosity of the carbon dioxide absorbent is decreased to degrade the carbon dioxide absorption and desorption property and shorten the life. Particularly, the inventors have found that, if the time taken to desorb carbon dioxide become longer, the above-mentioned granules of lithium metasilicate considerably grows to shorten the life.

Based on these findings, the inventors have made many investigations on the addition state of the alkaline carbonates, and accordingly have found that addition of 0.5 to 4.9% by mole of an absorption promoter containing potassium carbonate and sodium carbonate at a mole ratio of 0.125≦(sodium carbonate)/(potassium carbonate)≦0.4 to the lithium silicate gives a carbon dioxide absorbent capable of efficiently absorbing carbon dioxide in a low concentration, the carbon dioxide absorbent having a long life of the carbon dioxide absorption capability even in the case of repeat use. That is, absorption promoter containing potassium carbonate and sodium carbonate at a mole ratio in the defined range lowers the starting temperature of desorbing carbon dioxide and thus increases the desorption capability as compared with an absorption promoter containing potassium carbonate and sodium carbonate at a mole ratio out of the defined range. For this reason, the time of exposure of the lithium silicate to the liquefied lithium carbonate can be shortened and grain growth is hardly caused, and consequently, the carbon dioxide absorbent having the above-mentioned desirable properties can be obtained.

Next, a carbon dioxide separation apparatus according to the embodiment of the invention will be described in detail with reference to FIGURE.

First and second absorption cylinders 1₁ and 1₂ have a double structure composed of inner tubes 2₁, 2₂ and outer tubes 3₁, 3₂ respectively. Herein, the inside of each inner tube 2₁, 2₂ forms a reaction container, and a space formed between each inner tube 2₁, 2₂ and each outer tube 3₁, 3₂ provided at the circumference thereof is a space to which, for example, heat as heating means is supplied. Carbon dioxide absorbents 4₁, 4₂ having the above-mentioned composition are filled in the reaction containers. First and second carbon gas-containing gas supply branch pipes 6₁, 6₂ branched from a carbon gas-containing gas supply pipe 5 are connected to upper parts of the respective reaction containers. First and second valves 7₁, 7₂ are interposed in the first and second gas supply branch pipes 6₁, 6₂, respectively.

First and second gas supply branch pipes 9₁, 9₂ branched from a gas supply pipe 8 for recovering carbon dioxide are connected to upper parts of the respective reaction containers. Third and fourth valves 7₃, 7₄ are interposed in the first and second gas supply branch pipes 9₁, 9₂, respectively.

First and second gas discharge branch pipes 101, 10₂ are connected to lower parts of the respective reaction containers, and the other ends of these branch pipes 10₁, 10₂ are connected to a treated gas discharge pipe 11. A fifth valve 7₅ is interposed in the discharge pipe 11. First and second gas discharge branch pipes 12₁, 12₂ are connected to lower parts of the respective reaction containers, and the other ends of these branch pipes 12₁, 12₂ are connected to a recovered gas discharge pipe 13. A sixth valve 7₆ is interposed in the recovered gas discharge pipe 13.

A combustor 14 for burning a fuel gas is arranged adjacently to the first absorption cylinder 1₁. First and second combustion gas supply branch pipes 16₁, 16₂ branched from a combustion gas supply pipe 15 having one end connected to the combustor 14 are respectively connected to lower side faces of respective heating means. Seventh and eighth valves 7₇, 7₈ are interposed in the first and second combustion gas supply branch pipes 16₁, 16₂, respectively. First and second discharge pipes 17₁, 17_{y} are joined to communicate with the respective heating means. When a fuel gas is introduced into the combustor 14, the combustion gas burned therein is supplied to the respective heating means via the combustion gas supply pipe 15 and the first and second supply branch pipes 16₁, 16₂, and discharged out of the first and second discharge pipes 17₁, 17₂ via these spaces. While the combustion gas passes the respective spaces, the carbon dioxide absorbents 4₁, 4₂ filled in the respective reaction containers are heated.

The mole number of the flowing gas passing through the respective reaction containers per unit time is set to be about at least 4 times as much and at highest 50 times as much to the mole number of the filled carbon dioxide absorbents 4₁, 4₂. If the mole number of the flowing gas per unit time exceeds about 50 times as much, it becomes difficult to efficiently absorb carbon dioxide in terms of the capacity utilization factor of the reaction containers. On the other hand, if the mole number of the flowing gas per unit time is less than about 4 times as much, the quantity of heat generation following the absorption reaction may become so high as to disturb the absorption reaction itself owing to temperature increase of the flowing gas. In terms of both capacity utilization factor of the absorption cylinders and acceleration of the absorption reaction, the mole number of the flowing gas per unit time is more desirable to be not lower than about 8 times as much and not higher than about 30 times as much.

An operation method for carbon dioxide absorption and desorption using the above-mentioned carbon dioxide separation apparatus will be described.

In the two reaction containers having the carbon dioxide absorbents 4₁, 4₂ housed therein, carbon dioxide absorption reaction and carbon dioxide desorption reaction are reciprocally carried out in the following procedures (1-1) and (1-2) to continuously carry out absorption and desorption of carbon dioxide.

(1-1) Carbon Dioxide Absorption Operation in First Absorption Cylinder 1₁

First, the first valve 7₁ interposed in the first branch pipe 6₁ connected to the inner tube 2₁ (the first reaction apparatus) of the first absorption cylinder 1₁ and the fifth valve 7₅ interposed in the treated gas discharge pipe 11 are opened while the other valves 7₂, 7₃, 7₄, 7₅, 7₆, 7₇, and 7₈ are closed. A carbon dioxide-containing gas is supplied to the first reaction container through the first branch pipe 6₁ from the carbon dioxide-containing gas supply pipe 5. At that time, the mole number of the flowing gas passing through the respective reaction container per unit time is set to be about at least 4 times as much and at highest 50 times as much to the mole number of the filled lithium silicate as described above. Therefore, carbon dioxide in the carbon dioxide-containing gas is quickly absorbed and kept in the carbon dioxide absorbent 4₁. The gas with a decreased concentration of carbon dioxide is discharged through the first gas branch pipe 10₁ and the treated gas discharge pipe 11.

Carbon dioxide absorption is carried out by a similar operation in the second absorption cylinder 1₂.

(1-2) Carbon Dioxide Recovery Operation from Second Absorption Cylinder 1₂

During the time when the carbon dioxide absorption operation in the first absorption cylinder 1₁ is carried out as described in (1-1), the fourth valve 7₄ interposed in the second branch pipe 9₂ connected to the second absorption cylinder 1₂, the sixth valve 7₆ interposed in the recovered gas discharge pipe 13, and the eighth valve 7₈ interposed in the second combustion gas supply branch pipe 16₂ are opened. Thereafter, a combustion gas from the combustor 14 is led to the circulation space (the second heating means) composed of the inner tube 2₂ and the outer tube 3₂ via the combustion gas supply pipe 15 and the second combustion gas supply branch pipe 16₂. The carbon dioxide absorbent 4₂ filled in the inner tube 2₂ (the second reaction container) of the second absorption cylinder 1₂ is heated to about 800° C. or higher by circulation of the combustion gas. Simultaneously, a desired gas for recovery is supplied to the second reaction container via the second branch pipe 9₂ from the recovery gas supply pipe 8. At that time, the carbon dioxide absorbed in the carbon dioxide absorbent 4₂ is quickly desorbed by carbon dioxide desorption reaction, and the gas containing carbon dioxide in a high concentration can be recovered through the second recovery gas discharge branch pipe 12₂ and the recovery gas discharge pipe 13.

Carbon dioxide recovery is carried out by a similar operation in the first absorption cylinder 1₁.

As described, a carbon dioxide recovery operation from the second absorption cylinder 1₂ is carried out simultaneously with the time of carrying out a carbon dioxide absorption operation by the first absorption cylinder 1₁, and a carbon dioxide absorption operation by the second absorption cylinder 1₂ is carried out simultaneously with the time of carrying out a carbon dioxide recovery operation from the first absorption cylinder 1₁, and these operations repeatedly reciprocated to carry out continuous carbon dioxide separation.

The inner tubes 2₁, 2₂, the outer tubes 3₁, 3₂, the carbon dioxide-containing gas supply branch pipes 6₁, 6₂, the recovery gas supply branch pipes 9₁, 9₂, the gas discharge branches tubes 10₁, 10₂, and the recovered gas discharge branch pipes 12₁, 12₂ are made of various kinds of materials, for example, highly dense alumina, nickel or iron. Further, to efficiently separate carbon dioxide produced in the reaction container, it is desirable to increase the capacity of the heating means. In consideration of prolongation of the contact time of carbon dioxide and the carbon dioxide absorbents 4₁ 4₂, a long tubular shape in the gas flow direction is desirable.

Further, for example, a heater may be installed in the inside or outside of the reaction containers to control the temperature in the inside of the reaction containers corresponding to the carbon dioxide-containing gas.

As described above, according to this embodiment, it is possible to provide a carbon dioxide separation apparatus having a simplified structure and capable of continuously separating and recovering carbon dioxide at a low cost.

Hereinafter, Examples of the present invention will be described in detail.

### EXAMPLE 1

Silicon dioxide powder with an average particle diameter of 0.8 μm and lithium carbonate powder with an average particle diameter of 1 μm were weighed to adjust the mole ratio of (silicon dioxide):(lithium carbonate) to be 1:2. Further, potassium carbonate (K₂CO₃) powder and sodium carbonate (Na₂CO₃) powder with an average particle diameter of 1 μm were added to the obtained raw material powder while the mole ratio of (silicon dioxide):(lithium carbonate):(potassium carbonate):(sodium carbonate) to be 1:2:0.02:0.005. Successively, 10% by weigh of titanium oxide fiber was added to the mixed powder and mixed in dry state by using an agate crucible to obtain a mixed raw material powder. The obtained mixed raw material powder was treated in a box-shaped electric furnace in the atmosphere at 1000° C. for 8 hours to obtain powder containing lithium orthosilicate. The obtained powder was loaded in an extrusion molding apparatus and extrusion-molded into a column-like shape (outer diameter: 5 mm) to obtain a carbon dioxide absorbent of the porous material with a porosity of 50%.

### EXAMPLES 2 TO 7 AND COMPARATIVE EXAMPLES 1 TO 6

Carbon dioxide absorbents composed of porous materials were produced from the same materials in the same manner as in Example 1, except that the addition amounts of the potassium carbonate (K₂CO₃) powder and sodium carbonate (Na₂CO₃) powder were changed to adjust the ratios as described in the following Table 1.

With respect to the obtained column-like carbon dioxide absorbents of Examples 1 to 7 and Comparative Examples 1 to 6, the repeating property of absorption and desorption of carbon dioxide was evaluated by the following method.

CO₂ absorption was carried out by keeping each carbon dioxide absorbent at 600° C. for 1 hour under a condition of 10% CO₂ gas flow (1 atmospheric pressure/300 mL/min). CO₂ desorption was carried out by keeping each carbon dioxide absorbent absorbing carbon dioxide at 850° C. for 1 hour under a condition of 100% CO₂ gas flow (1 atmospheric pressure/300 mL/min). The carbon dioxide absorption capacity was calculated by measuring the weight increase ratio (wt. %/hour) for 1 hour of each carbon dioxide absorbent kept at 600° C. by thermogravimeter (TG).

The carbon dioxide absorption and desorption were repeated 50 times in the same temperature conditions as described, and the absorption capability at the 50th time was measured in the same manner on the basis of that at 1st time.

The repeat retention ratio was calculated from the following equation.
Repeat retention ratio=(absorption capability at 50th times repeat)/(absorption capability at first time repeat)

The results are shown in the following Table 1.

TABLE 1

| | K₂CO₃ addition | Na₂CO₃ addition | % by mole in total | Mole ratio of | Repeat retention |
|---|---|---|---|---|---|
| | amount (% by mole) | amount (% by mole) | of K₂CO₃ and Na₂CO₃ | Na₂CO₃/K₂CO₃ | ratio (%) |
| Example 1 | 2 | 0.5 | 2.05 | 0.25 | 95 |
| Example 2 | 2 | 0.25 | 2.25 | 0.125 | 92 |
| Example 3 | 2 | 0.4 | 2.4 | 0.2 | 95 |
| Example 4 | 2 | 0.8 | 2.8 | 0.4 | 90 |
| Example 5 | 1 | 0.25 | 1.25 | 0.25 | 94 |
| Example 6 | 3 | 0.75 | 3.75 | 0.25 | 94 |
| Example 7 | 0.4 | 0.1 | 0.5 | 0.25 | 92 |
| Comparative | 2 | 0 | 2.0 | — | 60 |
| Example 1 | | | | | |
| Comparative | 2 | 0.2 | 2.2 | 0.1 | 85 |
| Example 2 | | | | | |
| Comparative | 2 | 1 | 3.0 | 0.5 | 85 |
| Example 3 | | | | | |
| Comparative | 2 | 2 | 4.0 | 1 | 60 |
| Example 4 | | | | | |
| Comparative | 0 | 2 | 2.0 | ∞ | 40 |
| Example 5 | | | | | |
| Comparative | 0.3 | 0.075 | 0.375 | 0.25 | 83 |
| Example 6 | | | | | |

As is made clear from Table 1, the carbon dioxide absorbents of Examples 1 to 7 obtained by adding 0.5 to 4.9% by mole of the absorption promoter containing K₂CO₃ and Na₂CO₃ at mole ratio satisfying 0.125≦Na₂CO₃/K₂CO₃≦0.4 to the lithium silicate have higher repeat retention ratios as compared with those of the carbon dioxide absorbents of Comparative Examples 1 to 6 having the mole ratio and % by mole out of the defined ranges. That is, it is made clear that a carbon dioxide absorbent obtained by adding 0.5 to 4.9% by mole of the absorption promoter containing K₂CO₃ and Na₂CO₃ at mole ratio satisfying 0.125≦Na₂CO₃/K₂CO₃≦0.4 to a lithium silicate is little deteriorated by the repeated absorption and desorption and thus has a long life.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A carbon dioxide absorbent comprising:
(a) a lithium silicate; and
(b) an absorption promoter containing potassium carbonate and sodium carbonate at a mole ratio of (sodium carbonate)/(potassium carbonate) in a range from 0.125 to 0.4,
Wherein the absorption promoter (b) is contained in an amount of 0.5 to 4.9% by mole based on the total amount of the lithium silicate (a) and the absorption promoter (b).

2. The carbon dioxide absorbent according to claim 1, wherein the lithium silicate is lithium orthosilicate.

3. The carbon dioxide absorbent according to claim 1, wherein the mole ratio of (sodium carbonate)/(potassium carbonate) of the absorption promoter is in a range from 0.15 to 0.3.

4. The carbon dioxide absorbent according to claim 1, wherein the absorption promoter (b) is contained in an amount of a range from 2 to 4% by mole based on the total amount of the lithium silicate (a) and the absorption promoter (b).

5. The carbon dioxide absorbent according to claim 1, further containing a titanium-containing oxide.

6. The carbon dioxide absorbent according to claim 5, wherein the titanium-containing oxide is granular or fibrous.

7. The carbon dioxide absorbent according to claim 5, wherein an amount of the titanium-containing oxide is 40% by weight or less based on the total amount of the components (a) and (b) and the titanium-containing oxide.

8. The carbon dioxide absorbent according to claim 1, wherein the absorbent has a granular, column-like, disk-like or spherical shape with an average diameter of 50 μm or larger.

9. The carbon dioxide absorbent according to claim 1, wherein the absorbent is a porous material or having a honeycomb structure formed by extrusion molding.

10. The carbon dioxide absorbent according to claim 9, wherein the porous material has a porosity in a range from 30 to 70%.

11. A carbon dioxide separation apparatus comprising:
a reaction container having an inlet port which introduces carbon dioxide and an exhaust port which discharges a produced gas;
a carbon dioxide absorbent housed in the reaction container and comprising: (a) lithium silicate; and (b) an absorption promoter containing potassium carbonate and sodium carbonate at a mole ratio of (sodium carbonate)/(potassium carbonate) in a range from 0.125 to 0.4, the absorption promoter being contained in an amount of 0.5 to 4.9% by mole based on the total amount of the lithium silicate (a) and the absorption promoter (b); and
heating means installed in the outer circumference of the reaction container, for supplying heat to the reaction container.

12. The carbon dioxide separation apparatus according to claim 11, wherein the mole ratio of (sodium carbonate)/(potassium carbonate) of the absorption promoter in the carbon dioxide absorbent is in a range from 0.15 to 0.3.

13. The carbon dioxide separation apparatus according to claim 11, wherein the absorption promoter (b) in the carbon dioxide absorbent is contained in an amount of a range from 2 to 4% by mole based on the total amount of the lithium silicate (a) and the absorption promoter (b).

14. The carbon dioxide separation apparatus according to claim 11, wherein the carbon dioxide absorbent further contains a titanium-containing oxide.

15. The carbon dioxide separation apparatus according to claim 11, wherein the carbon dioxide absorbent is a porous material or has a honeycomb structure formed by extrusion molding.
